(19) United States
(12) Patent Application Publication
(10) Pub. No.: US 2016/0330309 A1
(43) Pub. Date: Nov. 10, 2016

(54) Communal Telephone Base Communication Device

(71) Applicant: Derrick Gregory, San Antonio, TX (US)

(72) Inventor: Derrick Gregory, San Antonio, TX (US)

(21) Appl. No.: 14/706,966

(22) Filed: May 8, 2015

(51) Int. Cl. H04M 1/725; H04W 4/16; H04M 3/42

(52) U.S. Cl. CPC H04M 1/72502; H04M 3/42042; H04W 4/16

(57) ABSTRACT

A communal telephone base communication device for providing a docking station capable of communication over multiple assignable cellular phone lines includes a processor coupled to a docking station. The processor is configured for communicative coupling to a plurality of cellular telephone lines. A handset is selectively couplable to the docking station and is communicatively coupled to the processor wherein the handset is configured for telephonic communications through each of the cellular telephone lines.

### BACKGROUND OF THE DISCLOSURE

1. Field of the Disclosure

The disclosure relates to telephone communication devices and more particularly pertains to a new telephone communication device for providing a docking station capable of communication over multiple assignable cellular phone lines.

### SUMMARY OF THE DISCLOSURE

An embodiment of the disclosure meets the needs presented above by generally comprising a processor coupled to a docking station. The processor is configured for communicative coupling to a plurality of cellular telephone lines. A handset is selectively couplable to the docking station and is communicatively coupled to the processor wherein the handset is configured for telephonic communications through each of the cellular telephone lines.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a communal telephone base communication device according to an embodiment of the disclosure.

FIG. 2 is a back view of a handset of an embodiment of the disclosure.

FIG. 3 is a front view of a handset of an embodiment of the disclosure.

FIG. 4 is a bottom view of a handset of an embodiment of the disclosure.

FIG. 5 is a partially exploded top front side perspective view of an embodiment of the disclosure.

### DESCRIPTION OF THE PREFERRED EMBODIMENT

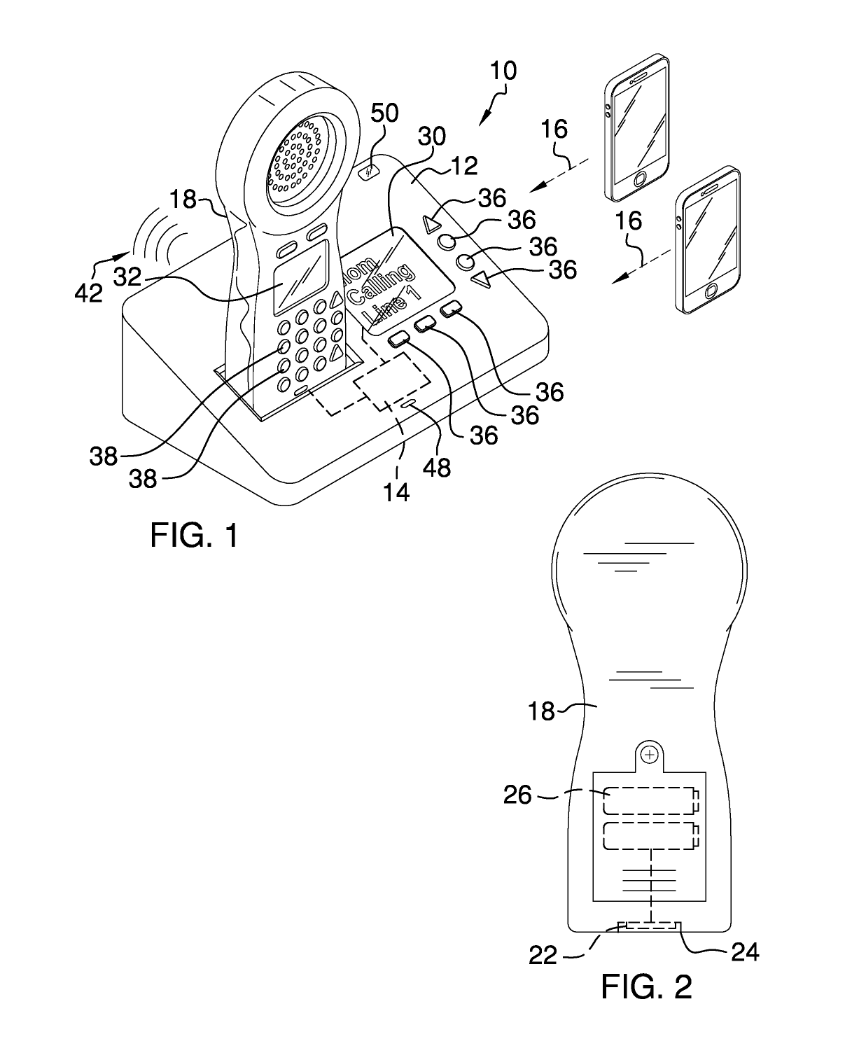

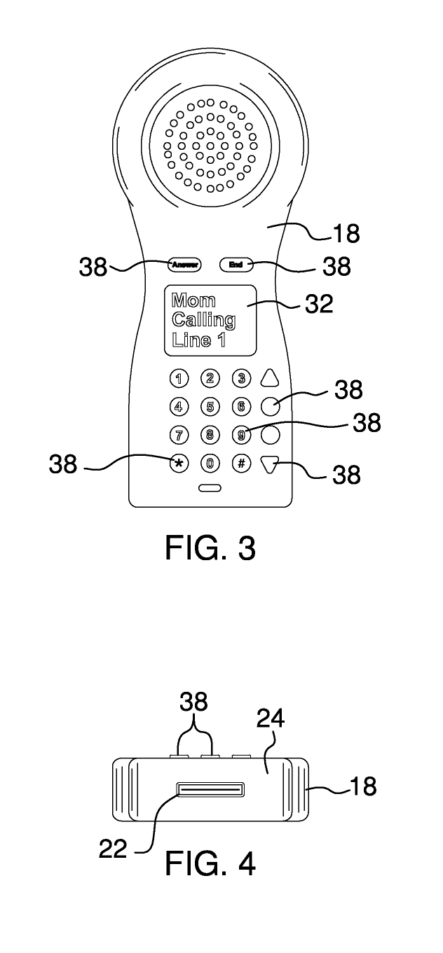

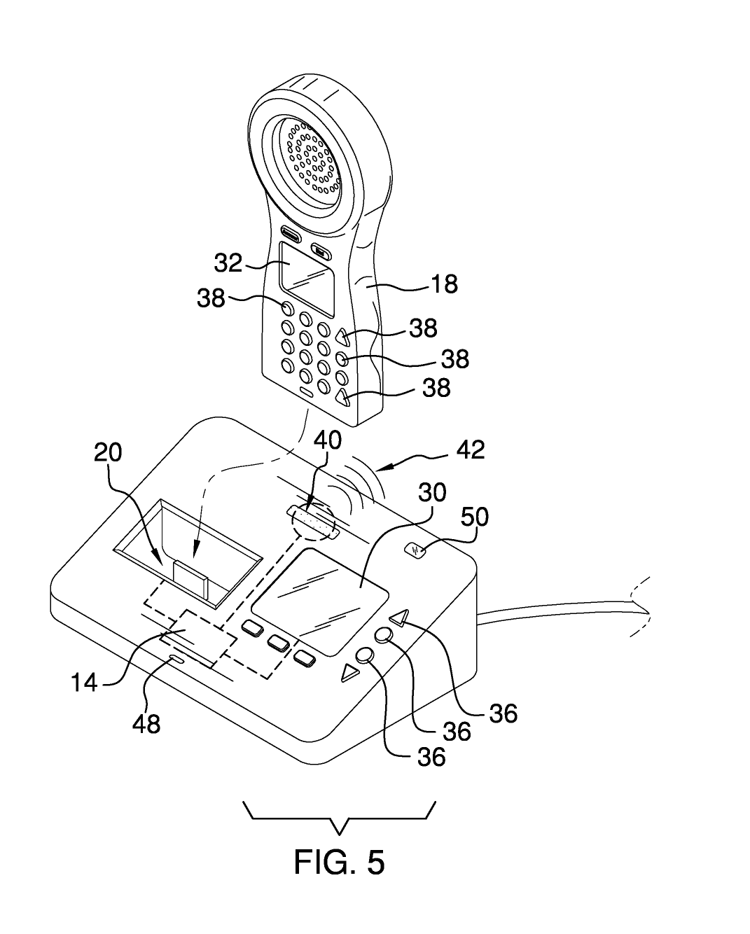

With reference now to the drawings, and in particular to FIGS. 1 through 5 thereof, a new telephone communication device embodying the principles and concepts of an embodiment of the disclosure and generally designated by the reference numeral 10 will be described.

As best illustrated in FIGS. 1 through 5, the communal telephone base communication device 10 generally comprises a docking station 12 and a processor 14 coupled to the docking station 12. The processor 14 is configured for communicative coupling to a plurality of extrinsic existing cellular telephone lines 16. A handset 18 is selectively couplable to the docking station 12 and communicatively coupled to the processor 14 wherein the handset 18 is configured for telephonic communications through each of the cellular telephone lines 16. Thus, the handset 18 may be used to receive and answer incoming calls made to any of the plurality of cellular phone lines 16. he handset 18 is wireless and removable from the docking station 12. The handset 18 is operational within a range of the docking station 12 using conventional wireless communications.

A charging port 20 is coupled to the docking station 12. The handset 18 is coupled to the charging port 20 when the handset 18 is placed on the docking station 12. The handset 18 has a base port 22 positioned on a bottom side 24 of the handset 18 complementary to the charging port 20 wherein the handset 18 is charged when the handset 18 is coupled to the docking station 12 by placing the handset 18 on the charging port 20. The handset 18 has a rechargeable battery 26 electrically coupled to the base port 22.

A base display screen 30 is coupled to the docking station 12. The processor 14 is coupled to the base display screen 30 wherein the base display screen 30 is configured to display caller identification for an incoming call from any of the cellular telephone lines 16. The base display screen 30 may also identify the specific line being used out of the plurality of cellular phone lines 16 operationally coupled to the handset 18 through the processor 14. A handset display screen 32 is coupled to the handset 18. The processor 14 is coupled to the handset display screen 32 wherein the handset display screen 32 is configured to display caller identification for an incoming call from any of the cellular telephone lines 16. The handset display screen 32 may display the information identical to the base display screen 30. Each of the base display screen 30 and the handset display screen 32 may also display other conventional information relating to operation of a telephonic communication system such as volume control and the like.

Each of a plurality of base buttons 36 is coupled to the docking station 12. Each of the base buttons 36 is coupled to the processor 14 providing inputs for operational control of the functions of the device 10. Similarly, each of a plurality of handset buttons 38 is positioned on the handset 18 and communicatively coupled to the processor 14 for operational control of the handset 18 and the other functions of the device 10.

A speaker 40 is coupled to the docking station 12. The speaker 40 is operationally coupled to the processor 14 wherein the speaker transmits an alert signal 42 upon the processor 14 receiving an incoming call on any one of the cellular telephone lines 16. The alert signal 42 comprises a plurality of unique sounds or sound files which may be songs, chimes, beeps, or the like. Each of the unique sounds is assignable to a specific one of the cellular phone lines 16 wherein the alert signal 42 is configured for corresponding to each cellular telephone line 16 using a unique sound such that the alert signal 42 distinguishes which cellular telephone line 16 is receiving an incoming call.

A microphone 48 may be coupled to the docking station 12. The microphone 48 is coupled to the processor 14 to permit speakerphone functionality through the docking station 12. An LED light 50 may be positioned on the docking station 12 and coupled to the processor 14. The light 50 may indicate the processor 14 is activated and ready to receive incoming calls on the cellular telephone lines 16 or may be illuminated upon actual reception of an incoming call.

In use, the docking station 12 is placed in a desired position within an office, house, or the like. The processor 14 is communicatively coupled to operate with each of the cellular telephone lines 16 allowing for communications over any of the cellular telephone lines 16 using the handset 18. The handset 18 may be relied upon for use by multiple people within the desired location such that each individual associated with one of the cellular telephone lines may receive incoming calls without having to have their personal communication device present. Thus, persons may continue to communicate or receive incoming calls despite having left a personal communication device in a location remote from the docking station.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A communal telephone base communication device comprising:
a docking station;
a processor coupled to said docking station, said processor being configured for communicative coupling to a plurality of cellular telephone lines; and
a handset, said handset being selectively couplable to said docking station, said handset being communicatively coupled to said processor wherein said handset is configured for telephonic communications through each of the cellular telephone lines.

2. The device of claim 1, further comprising said handset being wireless.

3. The device of claim 1, further comprising a charging port coupled to said docking station, said handset being coupled to said charging port when said handset is placed on said docking station wherein said handset is charged when said handset is coupled to said docking station.

4. The device of claim 1, further comprising a base display screen coupled to said docking station, said processor being coupled to said base display screen wherein said base display screen is configured to display caller identification for an incoming call from any of said cellular telephone lines.

5. The device of claim 1, further comprising a handset display screen coupled to said handset, said processor being coupled to said handset display screen wherein said handset display screen is configured to display caller identification for an incoming call from any of said cellular telephone lines.

6. The device of claim 1, further comprising a plurality of base buttons, each of said base buttons being coupled to said docking station, each of said base buttons being coupled to said processor.

7. The device of claim 1, further comprising a plurality of handset buttons, each of said handset buttons being positioned on said handset, each of said handset buttons being communicatively coupled to said processor.

8. The device of claim 1, further comprising a speaker coupled to said docking station, said speaker being operationally coupled to said processor wherein said speaker transmits an alert signal upon said processor receiving an incoming call on any one of said cellular telephone lines.

9. The device of claim 8, further comprising said alert signal comprising a plurality of unique sounds, each of said unique sounds being assignable wherein said alert signal is configured for corresponding to each cellular telephone line such that said alert signal is configured for distinguishing which cellular telephone line is receiving an incoming call.

10. A communal telephone base communication device comprising:
a docking station;
a processor coupled to said docking station, said processor being configured for communicative coupling to a plurality of cellular telephone lines; and
a handset, said handset being selectively couplable to said docking station, said handset being communicatively coupled to said processor wherein said handset is configured for telephonic communications through each of the cellular telephone lines, said handset being wireless;
a charging port coupled to said docking station, said handset being coupled to said charging port when said handset is placed on said docking station wherein said handset is charged when said handset is coupled to said docking station;
a base display screen coupled to said docking station, said processor being coupled to said base display screen wherein said base display screen is configured to display caller identification for an incoming call from any of said cellular telephone lines;
a handset display screen coupled to said handset, said processor being coupled to said handset display screen wherein said handset display screen is configured to display caller identification for an incoming call from any of said cellular telephone lines;
a plurality of base buttons, each of said base buttons being coupled to said docking station, each of said base buttons being coupled to said processor;
a plurality of handset buttons, each of said handset buttons being positioned on said handset, each of said handset buttons being communicatively coupled to said processor; and
a speaker coupled to said docking station, said speaker being operationally coupled to said processor wherein said speaker transmits an alert signal upon said processor receiving an incoming call on any one of said cellular telephone lines, said alert signal comprising a plurality of unique sounds, each of said unique sounds being assignable wherein said alert signal is configured for corresponding to each cellular telephone line such that said alert signal is configured for distinguishing which cellular telephone line is receiving an incoming call.
